(19) United States
(12) Patent Application Publication
(10) Pub. No.: US 2008/0055775 A1
(43) Pub. Date: Mar. 6, 2008

(54) Magnetic head and information storage device

(75) Inventors: Yuko Miyake, Kawasaki (JP); Masaaki Matsuoka, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: Fujitsu Limited, Kawasaki-shi (JP)

(21) Appl. No.: 11/879,459

(22) Filed: Jul. 17, 2007

(30) Foreign Application Priority Data
Aug. 31, 2006 (JP) 2006-236862

(51) Int. Cl. G11B 5/127

(52) U.S. Cl. 360/110

(57) ABSTRACT

A magnetic head includes a magnetic pole placed opposite a surface of a recording medium and moving relatively to the surface in a direction along the surface, the magnetic pole generating a magnetic line of force that crosses the surface of the recording medium, and a coil that excites the magnetic pole. The magnetic pole has a number of layers stacked on one another in a direction along the movement relatively to the surface of the recording medium, and the layers include a most forward layer located at a most forward position of the movement and consisting of a first magnetic material and a most backward layer located at a most backward position of the movement and consisting of a second magnetic material having a saturation magnetic flux density higher than that of the first magnetic material and a coercive force larger than that of the first magnetic material.

### BACKGROUND OF THE INVENTION

1. Field of the Invention

The present invention relates to magnetic heads that apply magnetic fields to recording media and information storage devices that use magnetic fields to access information in recording media.

2. Description of the Related Art

The advancement of information societies has been continuously increasing the amount of information used. To deal with the increased amount of information used, it has been desirable to develop information recording technologies and information storage devices for significantly high recording densities. In particular, magnetic disks to which information accesses can be made using magnetic fields are gathering much attention as high-density recording media that allow information to be rewritten. Many researches and developments have been carried out to achieve, for example, a further increased recording density.

An in-surface recording technology for magnetizing a recording medium in a direction along its surface is widely used as a magnetic recording technology for recording information in a magnetic disk. However, in recent years, much effort has been made to develop perpendicular recording technologies for magnetizing a recording medium in a direction perpendicular to its surface. The perpendicular recording technology has the advantages of enabling an increase in the recording density in the circumferential direction of tracks (linear recording density) and hindering recorded information from being destroyed by thermal fluctuations. The perpendicular recording technology is expected to be widely applied instead of the in-surface recording technology in the future.

FIG. 1 is a diagram illustrating the operational principle of the perpendicular recording technology.

A magnetic head 10 shown in FIG. 1 includes a thin film coil 13 that generates a magnetic field corresponding to information, a main magnetic pole 11 that generates a magnetic flux corresponding to the magnetic field generated by the thin film coil 13, and an auxiliary magnetic pole 12 that picks up the magnetic flux generated by the main magnetic pole 11 to feed it back to the thin film coil 13 and main magnetic pole 11. The magnetic head 10 also includes a reproduction head 14 that uses a reproduction element 14a to sense a magnetic field to read information recorded on the magnetic disk 1.

The magnetic disk 1 has a recording layer 1A and a soft magnetic layer 1B stacked on a substrate 1C; information is recorded in the recording layer 1A and the soft magnetic layer 1B is composed of a soft magnetic substance. The magnetic disk 1 is rotationally driven in the direction of arrow R to move the magnetic head 10 over and relatively to the magnetic disk 1 in the direction of arrow R′ opposite to the direction of arrow R.

To record information, an electric recording signal is input to the thin film coil 13 to allow the thin film coil 13 generate a magnetic field in a direction corresponding to the information. The magnetic field generated is supplied to the main magnetic pole 11, which generates a magnetic flux corresponding to the magnetic pole. The magnetic flux is applied to the magnetic disk 1 and passes through the soft magnetic layer 1B in the magnetic disk 1. The magnetic flux is diffused and then returns to the auxiliary magnetic pole 12, which then supplies the magnetic flux to the thin film coil 13 and main magnetic pole 11. The flow of the magnetic flux returning through the soft magnetic layer 1B while drawing a U-shaped magnetic path forms a recording magnetic field. The recording layer 1A is magnetized perpendicularly to its own surface to allow information to be recorded in itself.

Known problems with the magnetic head 10 based on the perpendicular recording technology as shown in FIG. 1 include a pole erase and a side erase; in the pole erase, residual magnetization remaining in the main magnetic pole 11 leaks and is applied to the magnetic disk 1 to erase information already recorded on the magnetic disk 1, and in the side erase, the magnetic head is skewed to destroy information recorded in adjacent tracks. Since the magnetic head 10 moves over and relatively to the magnetic disk 1 in the direction of arrow R′, the pole erase or side erase may erase information recorded on the magnetic disk 1 over a wide range or erase even servo information indicating the position on the magnetic disk 1, preventing the position of the magnetic head 10 from being controlled.

To prevent these problems, a known method produces the main magnetic pole of the magnetic head using an FeNi alloy or the like which effectively inhibits pole erase. However, the FeNi alloy offers a lower saturation magnetic flux density than an FeCo alloy or the like which has hitherto been used as a material of the main magnetic pole. Consequently, the FeNi allow may lower recording density.

To inhibit the pole erase and to achieve a high recording density, Japanese Patent Laid-Open No. 2004-281023 describes a technique using a main magnetic pole having multiple ferromagnetic materials and multiple nonmagnetic materials alternately stacked in the moving direction R′ of the magnetic head. Japanese Patent Laid-Open No. 2003-242608 describes a technique for forming a facing surface of the main magnetic pole which faces the magnetic disk so that the opposite surface is narrower toward the inlet of the magnetic disk (frontward of moving direction R′ of the magnetic head) and wider toward the outlet of the magnetic disk (backward of moving direction R′ of the magnetic head). According to the technique described in Japanese Patent Laid-Open No. 2004-281023, two ferromagnetic layers composed of a ferromagnetic material are disposed opposite to each other via a nonmagnetic layer composed of a nonmagnetic material. The magnetizations in the ferromagnetic layers thus act in the opposite directions to enable a reduction in residual magnetization. The technique described in Japanese Patent Laid-Open No. 2003-242608 allows magnetic fluxes to efficiently concentrate at the tip of the main magnetic pole, enabling an increase in recording density. Accordingly, a combination of the techniques described in Japanese Patent Laid-Open Nos. 2004-281023 and 2003-242608 is expected to allow both the inhibition of pole erase and an increased recording density.

However, the technique described in Japanese Patent Laid-Open No. 2004-281023 considerably limits the combination of the ferromagnetic material (for example, FeCo) and nonmagnetic material (for example, Ru) constituting the main magnetic pole. For example, if the main magnetic pole is produced by combining FeCo and Ru, a plating method, which is economically excellent and suitable for mass production, cannot be used to stack these layers. As a result, the stacking method is almost limited to a sputtering method, unfortunately increasing manufacturing costs. Further, the side erase cannot be sufficiently inhibited by using the techniques described in Japanese Patent Laid-Open Nos. 2004-281023 and 2003-242608.

### SUMMARY OF THE INVENTION

The invention has been made in view of the above circumstances and provides a magnetic head and an information storage device which can suppress an increase in manufacturing costs and achieve both the inhibition of the pole erase and side erase and an increased recording density.

The invention provides a magnetic head including:

a magnetic pole being placed to face a surface of a recording medium and moving relatively to the surface in a direction along the surface, the magnetic pole generating a magnetic line of force which crosses the surface of the recording medium; and

a coil that excites the magnetic pole,

wherein the magnetic pole has a number of layers stacked on one another in a direction along the movement relatively to the surface of the recording medium, and the layers include a most forward layer located at a most forward position of the movement and consisting of a first magnetic material and a most backward layer located at a most backward position of the movement and consisting of a second magnetic material having a saturation magnetic flux density higher than that of the first magnetic material and a coercive force larger than that of the first magnetic material.

The pole erase is known to correlate strongly with the coercive force of the magnetic pole. Inhibition of the pole erase thus requires a reduction in the coercive force of the magnetic pole. On the other hand, an increase in the recording density of the magnetic head requires the magnetic pole to offer a high saturation magnetic flux density.

According to the magnetic head in accordance with the invention, the material of the magnetic pole may be a combination of the first magnetic material having a low coercive force and the second magnetic material having a high saturation magnetic flux density. Both of these materials may be ferromagnetic. This extends the range of selectable materials to enable the combination of materials that can be stacked on each other by the plating method. This in turn makes it possible to achieve both the inhibition of the pole erase and an increased recording density without raising manufacturing costs. Further, the side erase occurs in the front of the magnetic pole in the moving direction of the magnetic head. According to the magnetic head in accordance with the invention, the most forward layer in the magnetic pole is composed of the first material, having a low saturation magnetic flux density. This enables the side erase to be efficiently hindered.

In the magnetic head in accordance with the invention, a cross section of the magnetic pole along the surface of the magnetic medium is preferably shaped to be narrower toward a front of a moving direction and wider toward a back of the moving direction.

The preferred magnetic head in accordance with the invention allows magnetic fluxes to efficiently concentrate at the tip of the magnetic pole. This enables an increase in recording density.

In the magnetic head in accordance with the invention, the first magnetic material and the second magnetic material preferably have a body-centered cubit lattice structure.

A combination of the magnetic materials having the body-centered cubic lattice structure allows the plating method to be used to stack these materials on each other.

In the magnetic head in accordance with the invention, the layers in the magnetic pole start with the most forward layer and end with the most backward layer and have layers consisting of the first magnetic material and layers consisting of the second magnetic material which are alternately stacked on one another.

When the layers consisting of the first magnetic material and the layers consisting of the second magnetic material are alternately stacked on one another, the saturation magnetic flux density and coercive force of the magnetic pole are uniformly adjusted. This allows the pole erase to be precisely inhibited, while enabling an efficient increase in recording density.

In the magnetic head in accordance with the invention, the layers in the magnetic pole as a whole have a saturation magnetic flux density of larger than 2.1 T and a coercive force of lower than 500 A/m.

The magnetic pole having a saturation magnetic flux density of larger than 2.1 T and a coercive force of lower than 500 A/m makes it possible to ensure both the inhibition of the pole erase and an increased recording density.

The invention also provides an information storage device that uses a magnetic field to access information on a recording medium, the device including:

a magnetic pole being placed to face a surface of a recording medium and generating a magnetic line of force which crosses the surface of the recording medium;

a coil that excites the magnetic pole; and

a moving mechanism that moves the magnetic pole relatively to the surface of the recording medium in a direction along the surface,

wherein the magnetic pole has a number of layers stacked on one another in a direction along the movement relatively to the surface of the recording medium, and the layers include a most forward layer located at a most forward position of the movement and consisting of a first magnetic material and a most backward layer located at a most backward position of the movement and consisting of a second magnetic material having a saturation magnetic flux density higher than that of the first magnetic material and a coercive force larger than that of the first magnetic material.

The information storage device makes it possible to inhibit the pole erase and to record information at a high recording density.

For the information storage device in accordance with the invention, only its basic form is shown. However, the information storage device in accordance with the invention includes not only the basic form but also various other forms corresponding to the above forms of the magnetic head.

The invention makes it possible to prevent an increase in manufacturing costs and a decrease in recording density and to inhibit the pole erase and side erase.

### BRIEF DESCRIPTION OF THE DRAWINGS

FIG. 1 is a diagram illustrating the operational principle of a perpendicular recording technology;

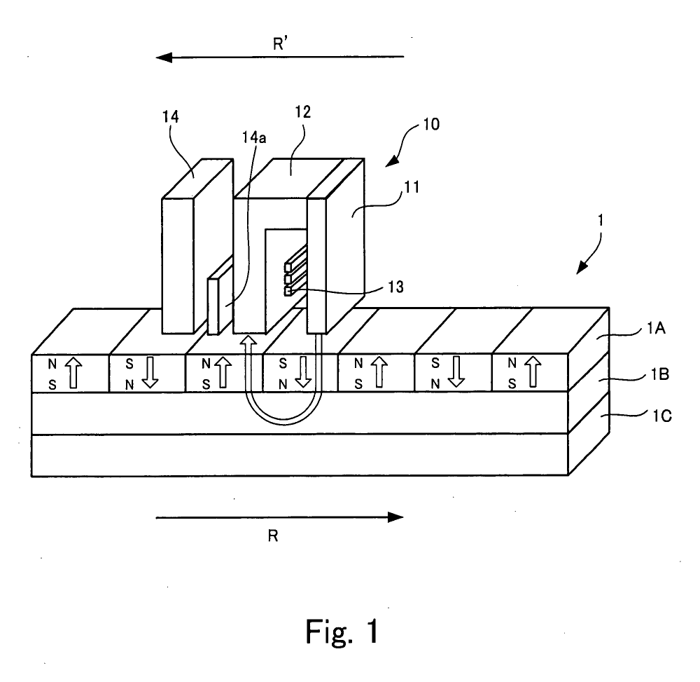

FIG. 2 is a diagram showing an embodiment of the invention;

FIG. 3 is a functional block diagram of a hard disk device;

FIG. 4 is a schematic diagram of configuration of a magnetic head;

FIG. 5 is a schematic diagram of tip of a main magnetic pole;

FIG. 6 is a diagram of the main magnetic pole as viewed from a magnetic disk;

FIG. 7 is a graph showing the relationship between the number of layers forming the main magnetic pole and the saturation magnetic flux density Bs and coercive force Hc of the main magnetic pole as a whole; and

FIG. 8 is a graph showing the saturation magnetic flux densities and coercive forces of various magnetic materials conventionally widely used as materials for the main magnetic pole.

### DETAILED DESCRIPTION OF THE INVENTION

The exemplary embodiments of the invention will be described with reference to the drawings.

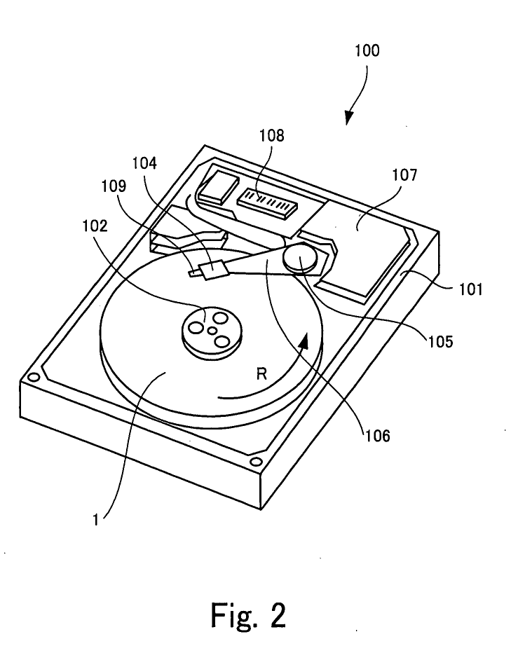

FIG. 2 is a diagram showing an embodiment of the invention.

A hard disk device 100 shown in FIG. 2 corresponds to an embodiment of an information storage device in accordance with the invention. An embodiment of a magnetic head in accordance with the invention is applied to the hard disk device 100. The hard disk device 100 is connected to or incorporated into a host apparatus represented by a personal computer or the like.

As shown in FIG. 2, a housing 101 of the hard disk device 100 accommodates a magnetic disk 1 on which information is recorded, a spindle motor 102 which rotates the magnetic disk 1 in the direction of arrow R, a floating head slider 104 located in proximity to and opposite a surface of the magnetic disk 1, an arm shaft 105, a carriage arm 106 having the floating head slider 104 secured to its tip and moving around the arm shaft 105 over and along the surface of the magnetic disk 1, a voice coil motor 107 that drives the carriage arm 106, and a control circuit 108 that controls the operation of the hard disk device 100. A combination of the spindle motor 102 and voice coil motor 107 corresponds to an example of a moving mechanism in accordance with the invention.

A magnetic head 109 is provided at a tip of the floating head slider 104 to apply a magnetic field to the magnetic disk 1. The hard disk device 100 uses this magnetic field to record information on the magnetic disk 1 and read information recorded on the magnetic disk 1. The hard disk device 100 inherently includes multiple magnetic disks 1 for each of which the magnetic head 109 is provided. However, for simplification, the description of the present embodiment focuses on one magnetic disk 1 and one magnetic head 109 provided for the magnetic disk 1.

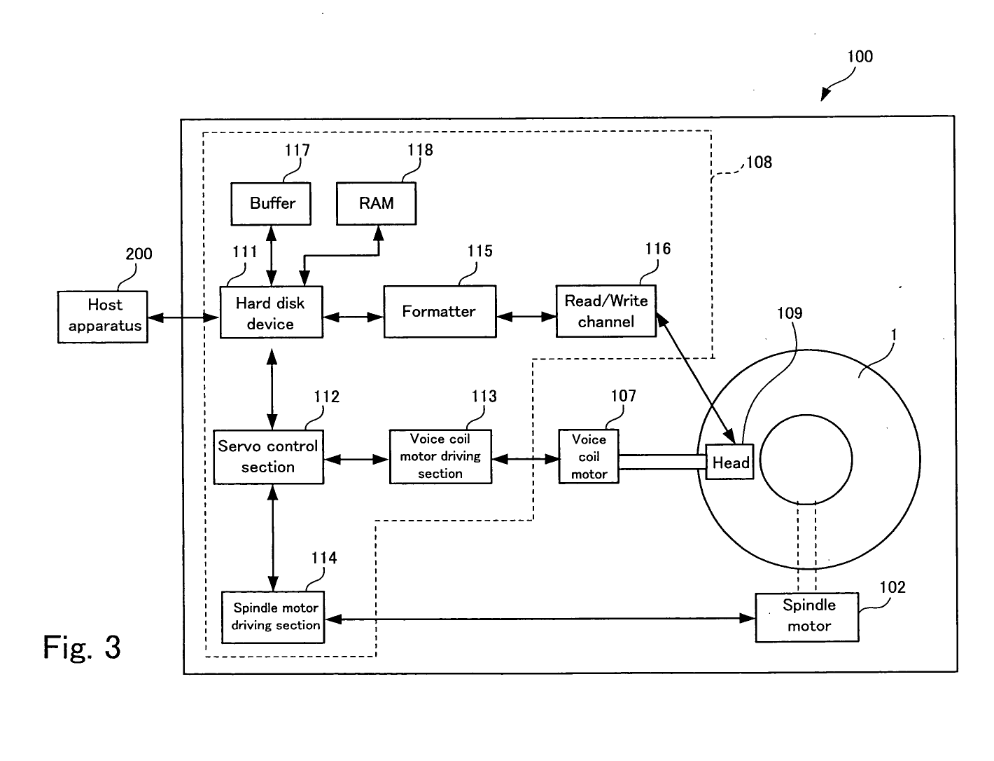

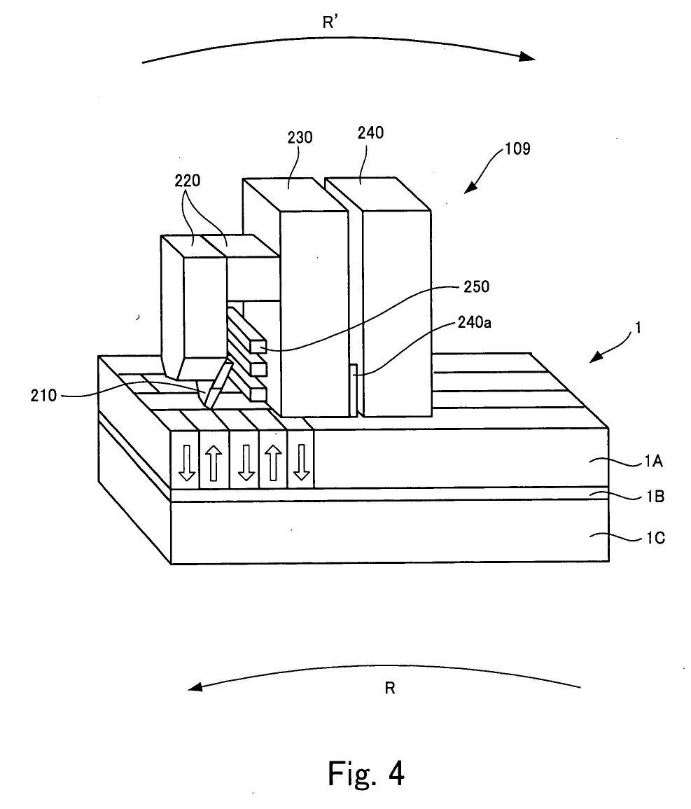

FIG. 3 is a functional block diagram of the hard disk device 100. FIG. 4 is a schematic diagram showing the configuration of the magnetic head 109.

As shown in FIG. 3, the hard disk device 100 includes the spindle motor 102, voice coil motor 107, control circuit 108, and magnetic head 109, which are also shown in FIG. 2. The control circuit 108 is composed of a hard disk control section 111 that controls the whole hard disk device 100, a servo control section 112 that controls the spindle motor 102 and voice coil motor 107, a voice coil motor driving section 113 that drives the voice coil motor 107, a spindle motor driving section 114 that drives the spindle motor 102, a formatter 115 that formats the magnetic disk 1, a read/write channel 116 that generates a write current carrying write information to be written to the magnetic disk 1 and that converts a reproduction signal obtained by reading information recorded on the magnetic disk 1 by the magnetic head 109, into digital data, a buffer 117 used as a cache for the hard disk control section 111, a RAM 118 used as a work area for the hard disk control section 111, and the like.

FIG. 4 shows the sectional structure of a part of the magnetic head 109. Rotation of the magnetic disk 1 in the direction of arrow R causes the magnetic head 109, positioned over the magnetic disk 1, to appear as if it moves in the direction of arrow R′ that is opposite to the rotating direction of the magnetic disk 1.

The magnetic head 109 has a main magnetic pole 210 that generates a magnetic flux, a coil 250 that generates a magnetic field, an auxiliary magnetic pole 230 that picks up the magnetic flux generated by the main magnetic pole 210 to feed it back to the main magnetic pole 210, and a reproduction head 240 that reads information recorded on the magnetic disk 1; these components are arranged in this order from the backward of the moving direction R′. The magnetic head 109 also includes a yoke 220 that couples the main magnetic pole 210 and the auxiliary magnetic pole 230 together. The main magnetic pole 210 corresponds to an example of a magnetic pole in accordance with the invention. The coil 250 corresponds to an example of a coil in accordance with the invention.

The magnetic disk 1 has a recording layer 1A and a soft magnetic layer 1B stacked on a substrate 1C; information is recorded in the recording layer 1A and the soft magnetic layer 1B is composed of a soft magnetic substance. The magnetic disk 1 corresponds to an example of a recording medium in accordance with the invention.

A method for accessing the magnetic disk 1 will be described with reference to FIGS. 3 and 4.

To write information to the magnetic disk 1, a host apparatus 200 shown in FIG. 3 sends the hard disk device 100 write information to be recorded on the magnetic disk 1 and a logical address for a write position. The hard disk control section 111 converts the logical address into a physical address and transmits the latter to the servo control section 112.

The servo control section 112 instructs the spindle motor driving section 114 to rotate the spindle motor 102. The servo control section 112 also instructs the voice coil motor driving section 113 to move the carriage arm 106 (see FIG. 2). The spindle motor driving section 114 drives the spindle motor 102 to rotate the magnetic disk 1. The voice coil motor driving section 113 drives the voice coil motor 107 to move the carriage arm 106. This allows the magnetic head 109 to be positioned over the magnetic disk 1.

Positioning of the magnetic head 109 causes the hard disk control section 111 to transmit a write signal to the read/write channel 116. The read/write channel 116 then applies a write current carrying write information to the magnetic head 109.

The write signal is input to a coil 250 in the magnetic head 109 which is shown in FIG. 4. The coil 250 generates a magnetic field in a direction corresponding to the write signal. The main magnetic pole 210 emits a magnetic flux corresponding to the magnetic field generated by the coil 250 to the magnetic disk 1. This forms magnetization acting in a direction corresponding to the information, in the recording layer 1A in the magnetic disk 1. The information is thus recorded on the magnetic disk 1. The magnetic flux having formed the magnetization in the recording layer 1A is returned to the auxiliary magnetic pole 230 through the soft magnetic layer 1B. The magnetic flux is then fed back to the main magnetic pole 210 via the yoke 220.

To read information recorded on the magnetic disk 1, the host apparatus 200, shown in FIG. 3, sends the hard disk device 100 a logical address for a recording position at which information is recorded. Then, as is the case with the information writing operation, the hard disk control section 111 converts the logical address into a physical address. The spindle motor 102 is rotationally driven to rotate the magnetic disk 1. The voice coil motor 107 is driven to move the carriage arm 106. This allows the magnetic head 109 to be positioned over the magnetic disk 1.

The magnetic head 109, shown in FIG. 4, has a reproduction element 240a incorporated therein to offer a resistance value corresponding to a magnetic field resulting from magnetization. Passing a current through the reproduction element 240a generates a reproduction signal corresponding to a magnetization state. The embodiment does not particularly limit the specific type of the reproduction element 240a. The reproduction element 240a may be, for example, a GMR (Giant MagnetoResistive) element or a TMR (Tunnel MagnetoResistive) element.

The reproduction signal is converted into digital data by the read/write channel 116, shown in FIG. 3. The digital data is then sent to the host apparatus 200 via the hard disk control section 111.

Basically, information accesses are made to the magnetic disk 1 as described above.

The magnetic head 109 will be described below in further detail.

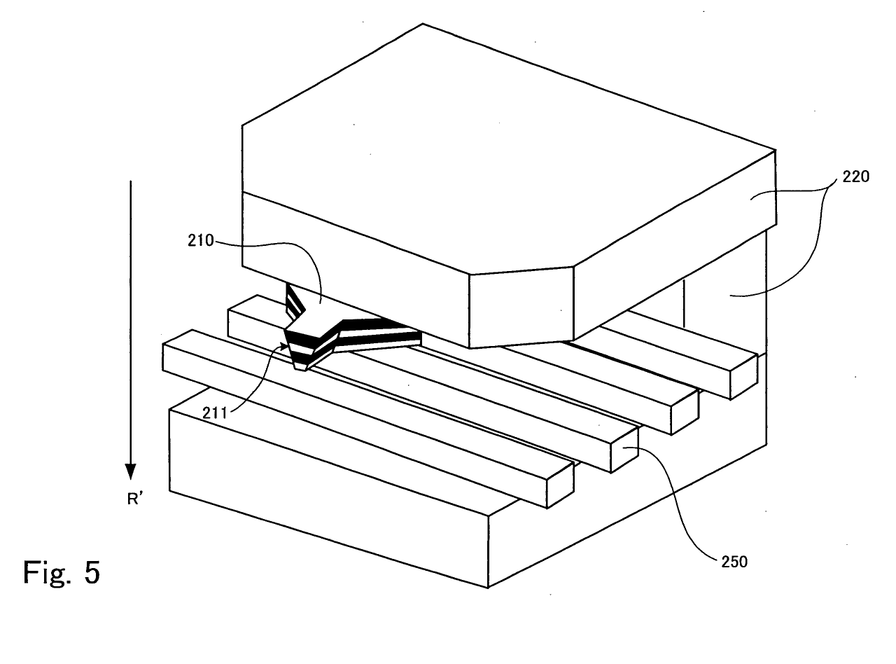

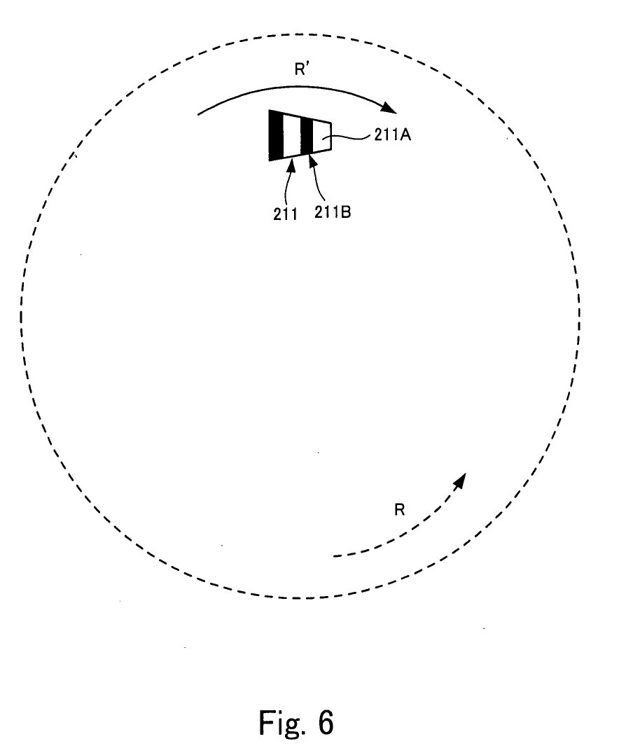

FIG. 5 is a schematic diagram of tip of the main magnetic pole 210. FIG. 6 is a diagram of the main magnetic pole 210 as viewed from the magnetic disk 1.

As shown in FIG. 5, the main magnetic pole 210 has a facing surface 211 located opposite the magnetic disk 1 and shaped to be narrower toward the front of the moving direction R′ of the magnetic disk 1 and wider toward the back of the moving direction R′. The main magnetic pole 210 tapered from back to front of the moving direction R′ makes it possible to control the side erase caused by an angle of yaw.

Further, as shown in FIG. 6, the main magnetic pole 210 has two layers of a first materials 211A and two layers of a second material 211B alternately stacked on one another along the moving direction R′ of the magnetic disk 1; the first material 211A is, for example, FeNi and has a saturation magnetic flux density Bs of 2.1 [T] and a low coercive force Hc of at most 200 [A/m], and the second material 211B is, for example, FeCo and has a high saturation magnetic flux density Bs of at least 2.3 [T]. The first material 211A corresponds to a first magnetic material in accordance with the invention. The second material 211B corresponds to a second magnetic material in accordance with the invention. In the embodiment, the layers of the first material 211A, which effectively inhibits the pole erase, and the layers of the second material 211B, to which information can be written at a high recording density, are alternately stacked on one another so that the first material 211A is located in the front of the moving direction R′, where the side erase is likely to occur, whereas the second magnetic material, to which information can be written at a high saturation magnetic flux density, is located in the back of the moving direction R′. This reduces the coercive force of the main magnetic pole as a whole below that of the second magnetic material to inhibit the pole erase. It is also possible to achieve both the inhibition of the side erase and an increased recording density. Furthermore, FeNi and FeCo are stacked films having different alloy compositions which belong to a high saturation magnetic flux density composition area and which have body-centered cubit lattice structures. However, advantageously, owing to their similar crystal structures, FeNi and FeCo can be grown in an almost uniform crystal state, with almost no damage layer formed between these layers. During the manufacture of the main magnetic pole 210, FeNi and FeCo can be stacked on one another by using a plating method superior in mass productivity and production cost.

As described above, the embodiment can suppress an increase in manufacturing costs and achieve both the inhibition of the pole erase and side erase and an increased recording density.

In the above example, the main magnetic pole has the two layers of the first material and the two layers of the second material alternately attacked on one another. However, the magnetic pole in accordance with the invention may have a total of four or more layers of the first magnetic material and second magnetic material. A third material different from the first and second magnetic materials may be additionally stacked. The third material may be nonmagnetic provided that it is conductive. If the third material is magnetic, it preferably offers as low a coercive force as possible in order to inhibit the pole erase and side erase.

When the first magnetic material and the second magnetic material are stacked, the saturation magnetic flux density Bs is the sum of saturation magnetic flux densities of all the layers. However, the coercive force Hc of the magnetic head as a whole depends on, for example, the crystallinity of the material constituting each layer. Consequently, the coercive force Hc of the magnetic head as a whole cannot be simply determined from the coercive force of each layer. It is thus preferable to make the layer of the second magnetic material, having a high saturation magnetic flux density, as thick as possible to increase the saturation magnetic flux density of the magnetic head as a whole and then to adjust the thickness of layer of the first magnetic material, offering a low coercive force, to reduce the coercive force of the magnetic head as a whole.

The second magnetic material in accordance with the invention may be FeCO (60<Fe<80 ar %), FeCoNi (55<Fe<80 at %, 20<Co<45 at %, 0<Ni<20 at %), or the like. The first magnetic material in accordance with the invention is preferably a FeNi alloy (Fe>75 at %), a FeCo alloy (Fe>75 at %), or the like. If a third material is stacked between the first magnetic material and the second magnetic material, it may be a permalloy, a 50% nickel permalloy, NiP, NiFeMo, NiMo, Ru, Pd, Pt, Rh, Cu, or the like.

### EXAMPLE

An example of the invention will be described.

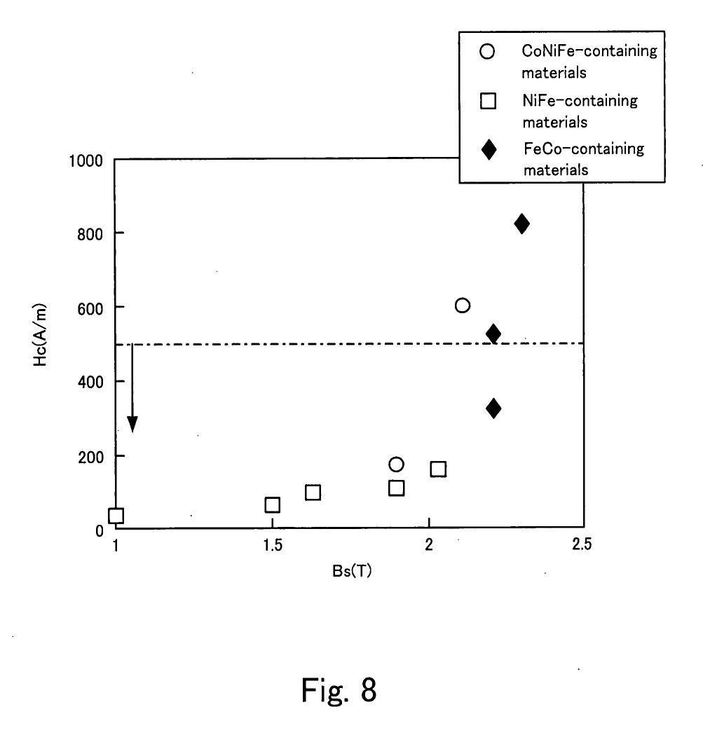

FIG. 8 is a graph showing the saturation magnetic flux densities and coercive forces of various magnetic materials conventionally widely used for the main magnetic pole.

In FIG. 8, the axis of abscissa is associated with the saturation magnetic flux density Bs [T]. The axis of ordinate is associated with the coercive force Hc [A/m]. CoNiFe-containing magnetic materials are plotted with circles. NiFe-containing materials are plotted with squares. FeCo-containing materials are plotted with rhombuses.

Normally, to inhibit the pole erase, the main magnetic pole needs to offer a coercive force Hc of at most 500 [A/m]. Further, to increase the recording density, the main magnetic pole needs to offer a saturation magnetic flux density Bs of at least 2.1 [T].

Disadvantageously, as shown in FIG. 8, the NiFe-containing materials (plotted with squares) offer coercive forces Hc of at most 500 [A/m] but too low saturation magnetic flux densities Bs. The CoNiFe-containing materials (plotted with circles) offer too large coercive forces Hc or too low saturation magnetic flux densities Bs, and none of them meets both conditions. Only one of the FeCo-containing materials (plotted with rhombuses) meets both conditions, whereas the others offer too high coercive forces Hc. Thus, very few materials formed into single layers can reliably achieve both an increased recording density and the inhibition of the pole erase.

Thus, the present example uses the main magnetic pole 210 that has a first material 211A having a low coercive force Hc and a second material 211B having a high saturation magnetic flux density Bs which are alternately stacked on each other as shown in FIG. 6. The first material 211A is FeNi, which has a saturation magnetic flux density Bs of more than 2 [T] and less than 2.1 [T] and a coercive force Hc of less than 300 [A/m]. The second material 211B is FeCo, which has a saturation magnetic flux density Bs of more than 2.3 [T] and a coercive force Hc of about 800 [A/m]. Layers of the first and second materials having the same film thickness are alternately stacked on one another by using a plating method so that the main magnetic pole is narrower toward the first material 211A side. Thus, the following are prepared: a main magnetic pole composed of a single second layer 211B and main magnetic poles composed of alternately stacked two, four, six, eight, or ten layers of the first material 211A and second material 211B. These main magnetic poles are used to measure the saturation magnetic flux density Bs and coercive force Hc of each main magnetic pole as a whole.

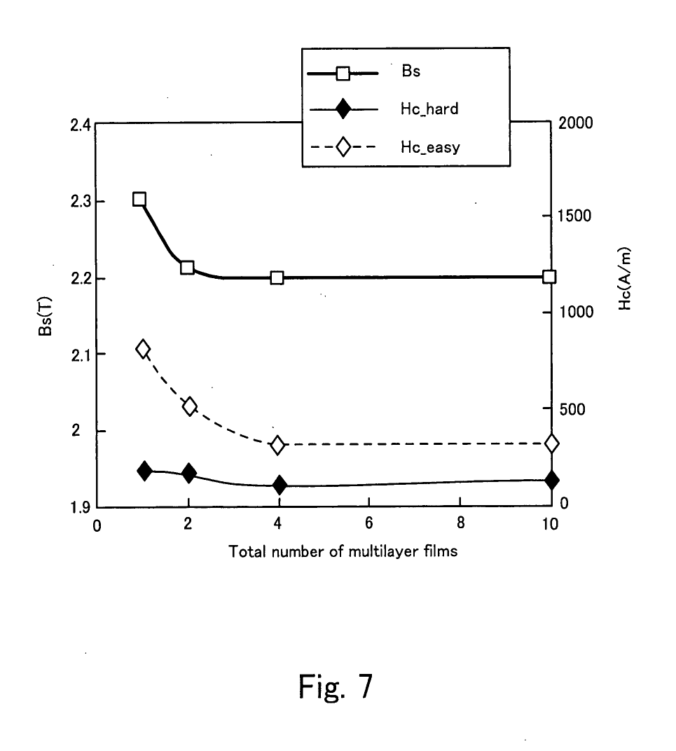

FIG. 7 shows the relationship between the number of layers forming the main magnetic pole and the saturation magnetic flux density Bs and coercive force Hc of the main magnetic pole as a whole.

In FIG. 7, the axis of abscissa is associated with the number of layers forming the main magnetic pole. The axis of ordinate is associated with the saturation magnetic flux density Bs [T] and coercive force Hc [A/m] of the main magnetic pole as a whole. The saturation magnetic flux density is plotted with squares. The coercive force in the hard axis of magnetization is plotted with black rhombuses. The coercive force in the easy axis of magnetization is plotted with white rhombuses.

As shown in FIG. 8, the main magnetic pole composed only of the second material 211B offers a coercive force Hc of more than 500 [A/m], which may cause the pole erase.

However, stacking the first material 211A and second material 211B on each other reduces the saturation magnetic flux density Bs and coercive force Hc of the main magnetic pole as a whole. Stacking four or more layers reduces the saturation magnetic flux density Bs down to about 2.2 [T] and the coercive force Hc down to about 300 [A/m]. This state satisfies both the coercive force Hc required to inhibit the pole erase (at most 500 [A/m]) and the saturation magnetic flux density Bs required to achieve an increased recording density (at least 2.1 [T]). This demonstrates the usefulness of the invention.

What is claimed is:

1. A magnetic head comprising:
a magnetic pole being placed to face a surface of a recording medium and moving relatively to the surface in a direction along the surface, the magnetic pole generating a magnetic line of force which crosses the surface of the recording medium; and
a coil that excites the magnetic pole,
wherein the magnetic pole has a plurality of layers stacked on one another in a direction along the movement relatively to the surface of the recording medium, and the plurality of layers include a most forward layer located at a most forward position of the movement and comprising a first magnetic material and a most backward layer located at a most backward position of the movement and comprising a second magnetic material having a saturation magnetic flux density higher than that of the first magnetic material and a coercive force larger than that of the first magnetic material.

2. The magnetic head according to claim 1, wherein a cross section of the magnetic pole along the surface of the recording medium is shaped to be narrower toward a front of the moving direction and wider toward a back of the moving direction.

3. The magnetic head according to claim 1, wherein the first magnetic material and the second material of the magnetic pole have a body-centered cubit lattice structure.

4. The magnetic head according to claim 1, wherein the plurality of layers in the magnetic pole start with the most forward layer and end with the most backward layer and include layers comprising the first magnetic material and layers comprising the second magnetic material which are alternately stacked on one another.

5. The magnetic head according to claim 1, wherein the plurality of layers in the magnetic pole as a whole have a saturation magnetic flux density of larger than 2.1 T and a coercive force of lower than 500 A/m.

6. An information storage device that uses a magnetic field to access information on a recording medium, the device comprising:
a magnetic pole being placed to place a surface of a recording medium and generating a magnetic line of force which crosses the surface of the recording medium;
a coil that excites the magnetic pole; and
a moving mechanism that moves the magnetic pole relatively to the surface of the recording medium in a direction along the surface,
wherein the magnetic pole has a plurality of layers stacked on one another in a direction along the movement relatively to the surface of the recording medium, and the plurality of layers include a most forward layer located at a most forward position of the movement and comprising a first magnetic material and a most backward layer located at a most backward position of the movement and comprising a second magnetic material having a saturation magnetic flux density higher than that of the first magnetic material and a coercive force larger than that of the first magnetic material.
